(19) United States
(12) Patent Application Publication
(10) Pub. No.: US 2009/0224052 A1
(43) Pub. Date: Sep. 10, 2009

(54) Standard omnidirectional barcode scanner

(76) Inventor: Kenneth Liou, Hsin-Tien City (TW)

Correspondence Address: Troxell Law Office Pllc, Suite 1404, 5205 Leesburg Pike, Falls Church, VA, 22041, US

(21) Appl. No.: 12/073,508

(22) Filed: Mar. 6, 2008

(51) Int. Cl. G06K 7/10

(52) U.S. Cl. 235/462.41

(57) ABSTRACT

A standard omnidirectional barcode scanner, including at least a casing and an electric circuit device, which is used to read one-dimensional bar codes and two-dimensional bar codes, and wherein an electric circuit device is formed with a CCD (Charge Coupled Device) image sensor or a CMOS (Complementary Metal-Oxide Semiconductor) image sensor made up of a plurality of linear CCDs or linear CMOSs arranged in an annular array at angular intervals. Each of the linear CCDs or linear CMOS is made up of a linear arrangement of a fixed number of optical sensors, thereby enabling the CCD image sensor or CMOS image sensor capture one-dimensional bar codes or two-dimensional bar codes at different angles, and substantially increasing reading time efficiency.

### BACKGROUND OF THE INVENTION

(a) Field of the Invention

A standard omnidirectional barcode scanner which uses a CCD (Charge Coupled Device) image sensor or CMOS (Complementary Metal-Oxide Semiconductor) image sensor formed from an annular array of a plurality of linear CCDs (Charge Coupled Devices) or linear CMOSs (Complementary Metal-Oxide Semiconductors) to enable reading of one-dimensional bar codes or two-dimensional bar codes.

(b) Description of the Prior Art

Current common bar codes can be divided into two broad categories, namely one-dimensional bar codes and two-dimensional bar codes, and after LEDs (Light Emission Diodes) are used to shine on the bar code, then optical elements, such as photosensitive CCDs (Charge Coupled Devices) or CMOSs (Complementary Metal-Oxide Semiconductors) receive the light rays reflected from the bar code, and the light rays are converted into electronic signals to serve as representative data for identifying the bar code.

Usually one-dimensional bar codes are read by linear CCDs, and two-dimensional bar codes are read by CCD image sensors. Referring to FIG. 1, which shows a schematic view depicting operation of a barcode scanner of the prior art, wherein a linear CCD or linear CMOS 101 is assembled to one side of a barcode scanner 10, and the linear CCD or linear CMOS 101 is made up of approximately 2000 optical sensors (that is, 2000 picture elements). When reading a one-dimensional bar code 20, light rays from LEDs 102 must completely shine on the one-dimensional bar code 20 in order to enable reflected light to reach the linear CCD or linear CMOS 101 for decoding thereof. However, during actual operation, because illumination range of the light rays from the LEDs 102 is limited and angle is fixed, thus, when the one-dimensional bar code 20 or the barcode scanner 10 are relatively askew relative to each other, then there is the possibility of dead space occurring when capturing the one-dimensional bar code 20, resulting in incomplete reading of or even the inability to read the bar code. Hence, the angle of the one-dimensional bar code 20 or the barcode scanner 10 must be adjusted at all times, which is extremely inconvenient for the operator. In addition, omnidirectional barcode scanners can be used to read two-dimensional bar codes and one-dimensional bar codes, and uses the method for capturing two-dimensional bar codes to capture one-dimensional bar codes. However, because the picture elements requiring processing by the system are increased a thousand-fold, thus, reading speed of the scanner is substantially reduced, and If a faster processor is used, then production costs are inevitably increased. However, and such expensive and slow reading speed omnidirectional barcode scanners are not easily adopted by customers using the extensively present one-dimensional bar code 20 in the market.

### SUMMARY OF THE INVENTION

In light of the shortcomings of the barcode scanners of the prior art, which often cause inconvenience in operation, have slow reading speed and high manufacturing cost when capturing one-dimensional bar codes or two-dimensional bar codes, the inventor of the present invention, has meticulously carried out extensive study and exploration to ultimately design a new improved structure for a standard omnidirectional barcode scanner.

A primary objective of the present invention is to provide the standard omnidirectional barcode scanner with convenient operation, and to improve reading efficiency thereof.

In order to achieve the aforementioned objective, the standard omnidirectional barcode scanner of the present invention comprises at least a casing and an electric circuit device, wherein the electric circuit device assembled within the casing, and a through hole is formed in one side of the casing. Moreover, a CCD (Charge Coupled Device) image sensor or a CMOS (Complementary Metal-Oxide Semiconductor) image sensor is formed to one side of the electric circuit device, and the CCD image sensor or CMOS image sensor is made up of a plurality of linear CCDs or linear CMOSs arranged in an annular array at angular intervals, thereby evenly dividing up the entire CCD image sensor or CMOS image sensor. Furthermore, each of the separate linear CCDs or linear CMOSs is made up of a linear arrangement of a fixed number of optical sensors, thereby enabling the CCD image sensor or CMOS image sensor to be used to read one-dimensional bar codes or two-dimensional bar codes.

Furthermore, reading characteristics of each of the separate linear CCDs or linear CMOSs of the CCD image sensor or CMOS image sensor of the standard omnidirectional barcode scanner of the present invention, and each of the separate linear CCDs or linear CMOSs set at respective corresponding angles are used to enable fast reading of one-dimensional bar code data by merely rotating the bar code or the barcode scanner through an appropriate angle when scanning and reading the one-dimensional bar code, which not only provides considerable convenience in operation, but also improves efficiency in reading one-dimensional bar codes. Furthermore, because of substantial reduction in the number of optical sensors used, thus, the standard omnidirectional barcode scanner of the present invention substantially lowers production cost.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view depicting operation of a barcode scanner of the prior art.

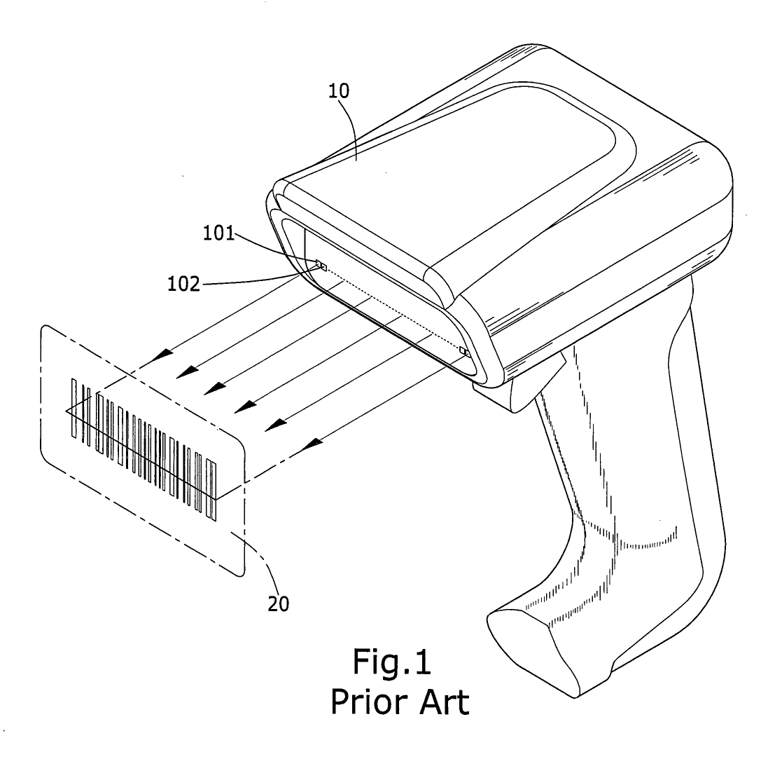

FIG. 2 shows a structural schematic view depicting a preferred embodiment of the present invention.

FIG. 3 shows a schematic view depicting operation of the preferred embodiment of the present invention.

FIG. 4 shows a structural schematic view depicting another preferred embodiment of the present invention.

### DETAILED DESCRIPTION OF THE PREFERRED EMBODIMENTS

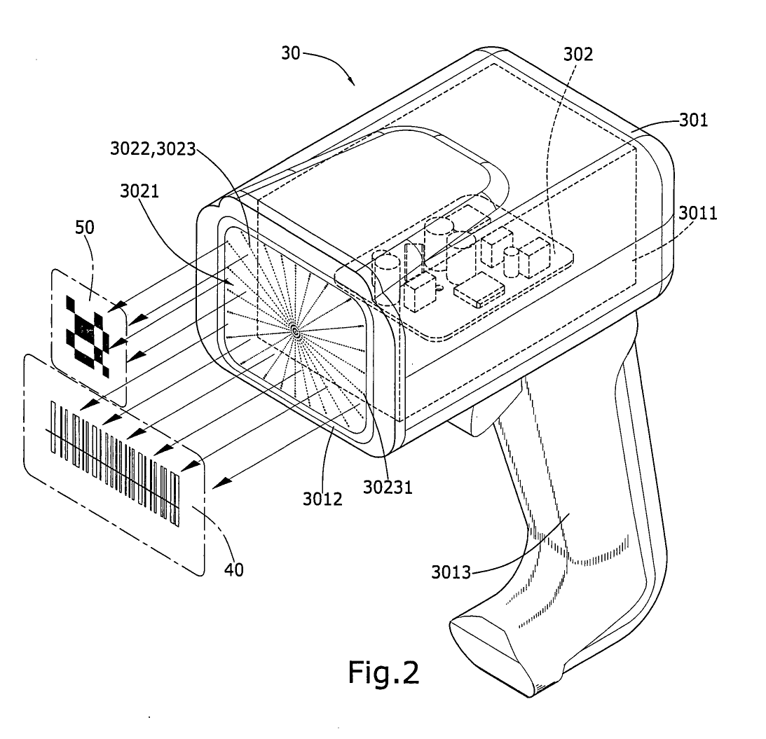

Referring to FIG. 2, which shows a structural schematic view depicting a preferred embodiment of the present invention, wherein a standard omnidirectional barcode scanner 30 of the present invention is being used to read data from a one-dimensional bar code 40 and a two-dimensional bar code 50. The standard omnidirectional barcode scanner 30 comprises at least: a casing 301, and in the embodiment a hand-held barcode scanner is used as an example, in which a holding space 3011 is formed inside the casing 301, and the holding space 3011 extends to one side of the casing 301 to form a through hole 3012 thereat. Moreover, a handle 3013 is formed on an underside of the casing 301. The present invention further comprises an electric circuit device 302, which is assembled within the holding space 3011 formed within the casing 301, and a CCD image sensor (Charge Coupled Device) or a CMOS image sensor (Complementary Metal-Oxide Semiconductor) 3021 is formed to one side of the electric circuit device 302, thereby enabling the CCD image sensor or CMOS image sensor 3021 to correspond with the through hole 3012 of the casing 301. When light from a light emitter 3022 (which can be a common laser point source or infrared light source) of the electric circuit device 302 passes through the through hole 3012 and transmitted towards the two-dimensional bar code 50, then reflected light from the light shining on the two-dimensional bar code 50 similarly passes through the through hole 3012, and is received by the CCD image sensor or CMOS image sensor 3021, thereby enabling the two-dimensional bar code 50 to be read. Furthermore, the CCD image sensor or CMOS image sensor 3021 is made up of a plurality of linear CCDs or linear CMOSs 3023, and in the preferred embodiment of the present invention, 12 of the linear CCDs or linear CMOSs 3023 are used, which are arranged in an annular array at angular intervals to form the CCD image sensor or CMOS image sensor 3021, and the angular interval between two adjacent linear CCDs or linear CMOSs 3023 is approximately 15 degrees. Moreover, the linear CCDs or linear CMOSs 3023 are further made up of a linear arrangement of approximately 2000 optical sensors 30231. Hence, the standard omnidirectional barcode scanner 30 uses approximately 24000 of the optical sensors 30231, which, when compared to the as many as 4,000,000 optical sensors used in standard omnidirectional barcode scanners of the prior art (not shown in the drawings), shows that the standard omnidirectional barcode scanner 30 of the present invention uses a substantially fewer number of the optical sensors 30231, thereby naturally reducing manufacturing cost, as well as increasing reading speed of the system. Furthermore, an applicable choice in the number of the linear CCDs or linear CMOSs 3023 can be made, whereby when the number of the linear CCDs or linear CMOSs 3023 used is relatively fewer, then the number of lines of the one-dimensional bar code 40 captured is correspondingly fewer, and thus dead space is increased during capture. However, when an excessive number of the linear CCDs or linear CMOSs 3023 are used, then the number of picture elements that the system needs to process correspondingly increases, and the reading speed naturally slows down. Consequently, data displays obtained through repeated tests carried out by the inventor of the present invention have shown that the preferred number of the linear CCDs or linear CMOSs 3023 is approximately 10 to 30, which makes the angular interval between adjacent linear CCDs or linear CMOSs 3023 approximately between 18 degrees and 6 degrees. Because each of the separate linear CCDs or linear CMOSs 3023 is made up of a linear arrangement of a fixed number of the optical sensors 30231, thus, a small angle adjustment enables each of the separate linear CCDs or linear CMOSs 3023 to read the one-dimensional bar code 40, which not only provides the operator with convenience of use, but also increases reading efficiency. Furthermore, when each of the separate linear CCDs or linear CMOSs 3023 reads the one-dimensional bar code 40, optimization processing is implemented within the system, and enables incomplete picture elements read by the linear CCDs or linear CMOSs 3023 to be rejected, or for the signals most captured by the linear CCDs or linear CMOSs 3023 to be preferentially decoded, thereby substantially increasing the speed of reading a bar code by the system.

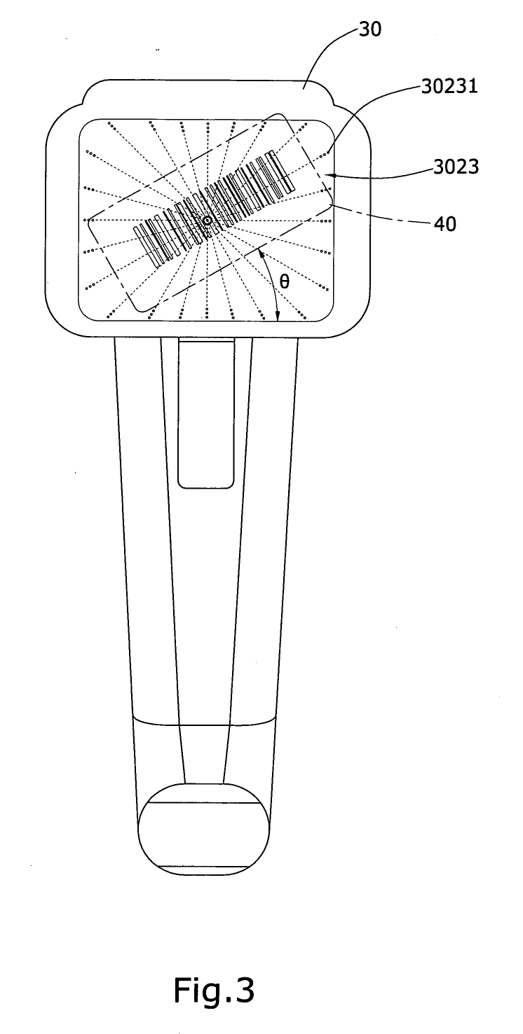

Referring to FIG. 3, which shows a schematic view depicting operation of the preferred embodiment of the present invention, wherein when the standard omnidirectional barcode scanner 30 of the aforementioned embodiment of the present invention is used to read the one-dimensional bar code 40 askew at an angle relative to the standard omnidirectional barcode scanner 30, then the operator can rotate either the one-dimensional bar code 40 or the standard omnidirectional barcode scanner 30 through an angle to align one of the linear CCDs or linear CMOSs 3023 with the angle of the one-dimensional bar code 40, thereby enabling the reflected light captured by the linear CCD or linear CMOS 3023 in principle to be still in a linear arrangement. Moreover, because the number of the optical sensors 30231 of each of the separate linear CCDs or linear CMOSs 3023 is the same, thus, the picture elements captured when reading the one-dimensional bar code 40 is also the same. However, during actual implementation, because there is a small gap between each pair of the adjacent optical sensors 30231, thus, when the reflected light after reading a bar code happens to pass through these gaps, then the nearest optical sensor 30231 capturing the one-dimensional bar code 40 functions similar to the single linear CCD or linear CMOS barcode scanner technology of the prior art (not shown in the drawings), and the signals from the one-dimensional bar code 40 captured by the aforementioned 12 linear CCDs or linear CMOSs 3023 are sent to the system processor for decoding, which immediately decodes the data represented by the one-dimensional bar code 40.

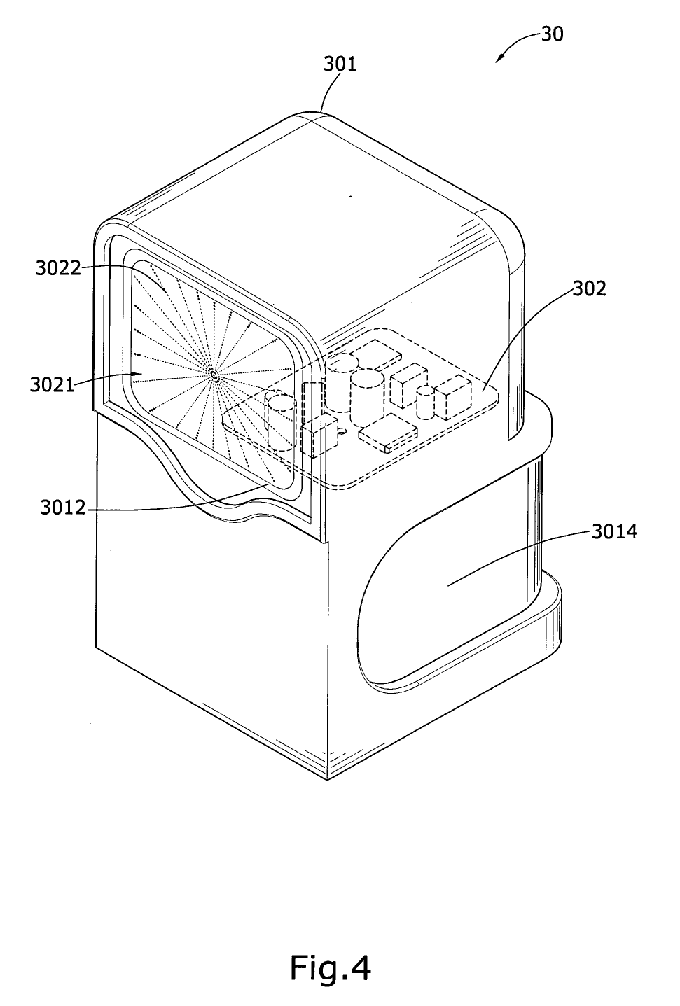

Referring to FIG. 4, which shows a structural schematic view depicting another preferred embodiment of the present invention, wherein the standard omnidirectional barcode scanner 30 of the present invention is shown to have further application in a general free-standing barcode scanner or a fixed type barcode scanner. Taking a free-standing barcode scanner as an example, which similarly comprises the casing 301 and the electric circuit device 302, in which the through hole 3012 is defined in one side of the casing 301, a base 3014 is assembled to the underside of the casing 301, and after the electric circuit device 302 is configured within the casing 301, then the CCD image sensor or CMOS image sensor 3021 at one side of the electric circuit device 302 is aligned with the through hole 3012, thereby enabling the light rays emitted by the light emitter 3022 to pass through the through hole 3012, after which the light rays of the reflected light from the one-dimensional bar code 40 or the two-dimensional bar code 50 again pass through the through hole 3012 and are received by the CCD image sensor or CMOS image sensor 3021, thereby enabling the aforementioned one-dimensional bar code 40 or the aforementioned two-dimensional bar code 50 to be read. Because the free-standing barcode scanner is a fixed type, thus, an operator can rotate a bar code in front of the CCD image sensor or CMOS image sensor 3021 to quickly capture the light rays reflected from the bar code for decoding of the data represented by the bar code.

According to what has been described above, the standard omnidirectional barcode scanner 30 of the present invention uses a plurality of the linear CCDs or linear CMOSs 3023 arranged in an annular array at angular intervals to form the CCD image sensor or CMOS image sensor 3021, and implementation of the present invention only requires slight rotation of a bar code or the barcode scanner 30 by an operator to enable each of the separate linear CCDs or linear CMOSs 3023 to quickly read one-dimensional bar codes positioned at different angles, thereby achieving the objectives of convenience of operation and high reading efficiency.

In conclusion, the standard omnidirectional barcode scanner 30 of the present invention possesses patent inventiveness and commercial utility value, and in accordance with patent law,: the applicant proposes an application for a new patent herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A standard omnidirectional barcode scanner, used to read one-dimensional bar codes and two-dimensional bar codes, comprising:
a casing, a through hole is formed in one side of the casing; and
an electric circuit device assembled within the casing, and a CCD (Charge Coupled Device) image sensor is formed to one side of the electric circuit device, thereby enabling the CCD image sensor to correspond with the through hole, the CCD -image sensor is made up of a plurality of linear CCDs arranged in an annular array at angular intervals, moreover, each of the separate linear CCDs is made up of a linear arrangement of a fixed number of optical sensors.

2. The standard omnidirectional barcode scanner according to claim 1, wherein the CCD image sensor enables reading of two-dimensional bar code data.

3. The standard omnidirectional barcode scanner according to claim 1, wherein each of the separate linear CCDs enables reading of one-dimensional bar code data.

4. The standard omnidirectional barcode scanner according to claim 3, wherein optimization processing is implemented when each of the separate linear CCDs reads a one-dimensional bar code.

5. The standard omnidirectional barcode scanner according to claim 1, wherein the number of the linear CCDs is approximately between 10 and 30, and angular interval between two adjacent linear CCDs is approximately 18 to 6 degrees.

6. The standard omnidirectional barcode scanner according to claim 1, wherein the linear CCDs are made up of linear arrangements of 2000 optical sensors.

7. The standard omnidirectional barcode scanner according to claim 1, wherein the electric circuit device is assembled with a light emitter.

8. The standard omnidirectional barcode scanner according to claim 7, wherein the light emitter is a laser point source.

9. The standard omnidirectional barcode scanner according to claim 7, wherein the light emitter is an infrared light source.

10. A standard omnidirectional barcode scanner, used to read one-dimensional bar codes and two-dimensional bar codes, comprising:
a casing, a through hole is formed in one side of the casing; and
an electric circuit device assembled within the casing, and a CMOS (Complementary Metal-Oxide Semiconductor) image sensor is formed to one side of the electric circuit device, thereby enabling the CMOS image sensor to correspond with the through hole, the CMOS image sensor is made up of a plurality of linear CMOSs arranged in an annular array at angular intervals, moreover, each of the separate linear CMOSs is made up of a linear arrangement of a fixed number of optical sensors.

11. The standard omnidirectional barcode scanner according to claim 10, wherein the CMOS image sensor enables reading of two-dimensional bar code data.

12. The standard omnidirectional barcode scanner according to claim 10, wherein each of the separate linear CMOSs enables reading of one-dimensional bar code data.

13. The standard omnidirectional barcode scanner according to claim 12, wherein optimization processing is implemented when each of the separate linear CMOSs reads a one-dimensional bar code.

14. The standard omnidirectional barcode scanner according to claim 10, wherein the number of the linear CMOSs is approximately between 10 and 30, and angular interval between two adjacent linear CMOSs is approximately 18 to 6 degrees.

15. The standard omnidirectional barcode scanner according to claim 10, wherein the linear CMOSs are made up of linear arrangements of 2000 optical sensors.

16. The standard omnidirectional barcode scanner according to claim 10, wherein the electric circuit device is assembled with a light emitter.

17. The standard omnidirectional barcode scanner according to claim 16, wherein the light emitter is a laser point source.

18. The standard omnidirectional barcode scanner according to claim 16, wherein the light emitter is an infrared light source.
